(19) United States
(12) Patent Application Publication
(10) Pub. No.: US 2008/0090455 A1
(43) Pub. Date: Apr. 17, 2008

(54) Electrical connector with improved board locks

(75) Inventors: Zi-Qiang Zhu, Kunshan (CN); Xing-Hai Xiang, Kunshan (CN); Kai Chen, Kunshan (CN); Xiao-Hui Yin, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/974,572

(22) Filed: Oct. 15, 2007

(30) Foreign Application Priority Data
Oct. 16, 2006 (CN) 200620126459.7

(51) Int. Cl. H01R 13/434; H01R 13/436

(52) U.S. Cl. 439/567; 439/752

(57) ABSTRACT

An electrical connector (100) includes an insulative housing (10), a number of contacts (20) retained in the insulative housing, a metal shell (30) shielding the insulative housing, and a pair of board locks (40). The insulative housing has a body portion (11) and a mating portion (12). The body portion defines a pair of receiving spaces (14) extending therethrough. Each board lock has a first plate (41) with a hollow cylinder (44) and a hook section (42) extending out of the insulative housing. The metal shell defines a pair of through holes (33) corresponding to the hollow cylinders respectively. The metal shell and the insulative housing sandwich the first plates of the board locks therebetween.

### BACKGROUND OF THE INVENTION

1. Field of the Invention

The present invention relates to an electrical connector, and more particularly to an electrical connector with improved board locks.

2. Description of Related Art

U.S. Pat. No. 6,012,954 discloses a conventional electrical connector which comprises an insulative housing, a plurality of terminals received in the insulative housing, a shell partially enclosing the housing, a pair of board locks and a pair of fasteners for assembling the board locks onto the housing. Each fastener has a first plate and a hollow cylinder extending from the first plate. The hollow cylinder extends through a through hole of the board lock with the first plate to abut against the board lock on a rear side of the insulative housing. The hollow cylinder further extends through the housing and the shell to abutting against a front surface. Therefore, the housing, the shell, and the board lock are secured together by the fastener. Since the connector needs a fastener to be assembled as a whole and to establish a grounding path between the shell and the board lock, the number of the elements of the connector is increased and complicated the structure of the connector. As a result, the cost of the connector is also increased.

Hence, an improved electrical connector is needed to solve the problem above.

### BRIEF SUMMARY OF THE INVENTION

Accordingly, a main object of the present invention is to provide an electrical connector with improved board lock for easy assembly and reducing cost.

In order to obtain the object, an electrical connector comprises an insulative housing, a plurality of contacts retained in the insulative housing, a metal shell shielding the insulative housing, and a pair of board locks. The insulative housing has a body portion and a mating portion. The body portion defines a pair of receiving spaces extending therethrough. Each board locks comprises a first plate with a hollow cylinder, a hook section extending out of the insulative housing, and a connect section connect the first plate with the hook section. The metal shell defines a pair of through holes corresponding to the hollow cylinders respectively. The metal shell and the insulative housing sandwich the first plates of the board locks therebetween.

The body portion and mating portion of the insulative housing can be separated. The electrical connector further comprises a full-proofing device for insuring the body portion and mating portion mating with each other accurately. The full-proofing device is arranged only on one side of the electrical connector and includes a post and a slit fitting with each other. The post and the slit being arranged on the body portion and the mating portion respectively.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector according to the present invention;

FIG. 2 is a perspective view of the electrical connector shown in FIG. 1, showing the metal shell detaching from the housing;

FIG. 3 is similar to FIG. 2, but viewed from another aspect;

FIG. 4 is an exploded view of the electrical connector shown in FIG. 1; and

FIG. 5 is similar to FIG. 4, but viewed from another aspect.

### DETAILED DESCRIPTION OF THE PREFERRED EMBODIMENT

Reference will be made to the drawing figures to describe the present invention in detail, wherein depicted elements are not necessarily shown to scaf

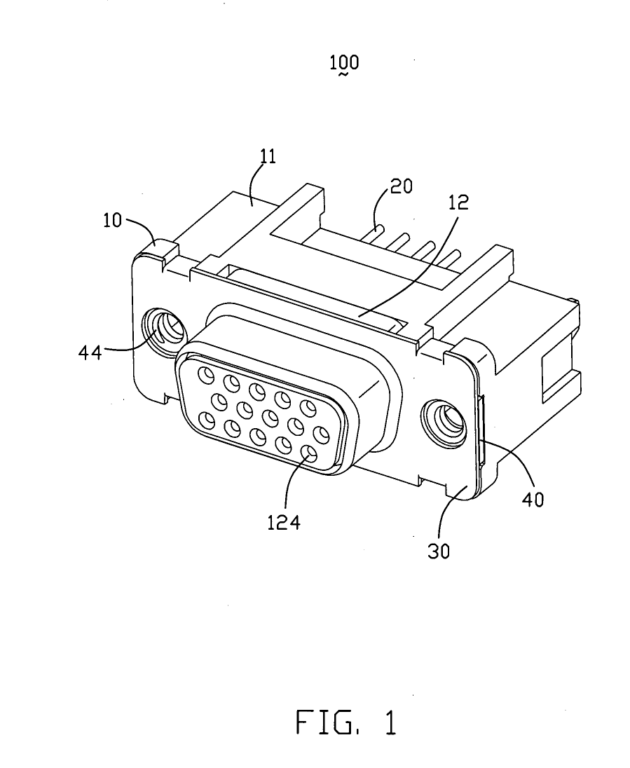

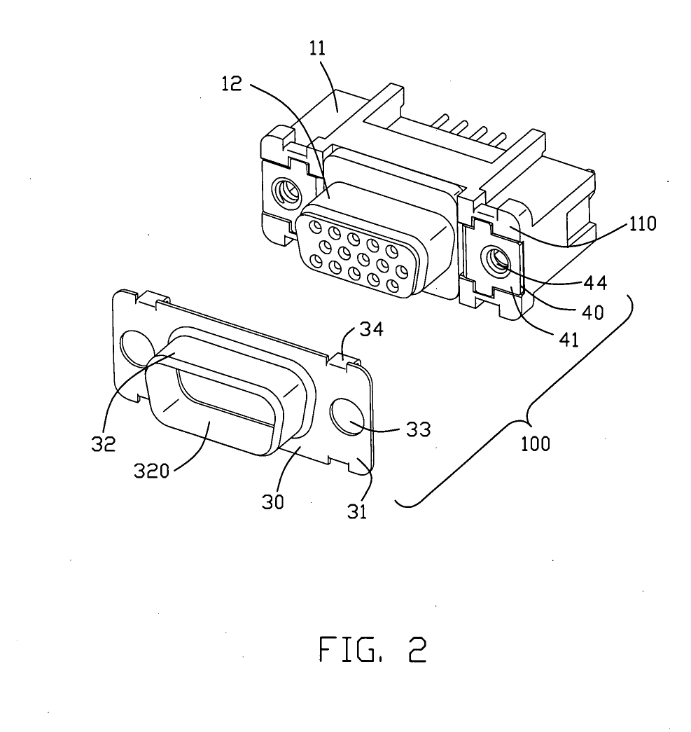

Referring to FIGS. 1-3, an electrical connector 100 includes an insulative housing 10, a plurality of contacts 20 retained in the insulative housing 10, a metal shell 30 partially enclosing the insulative housing 10, and a pair of integrated board locks 40.

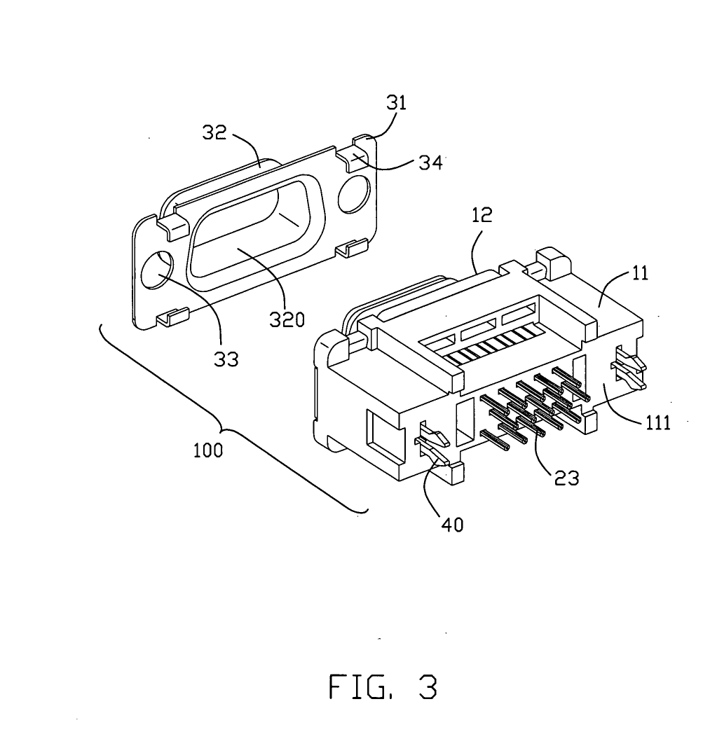

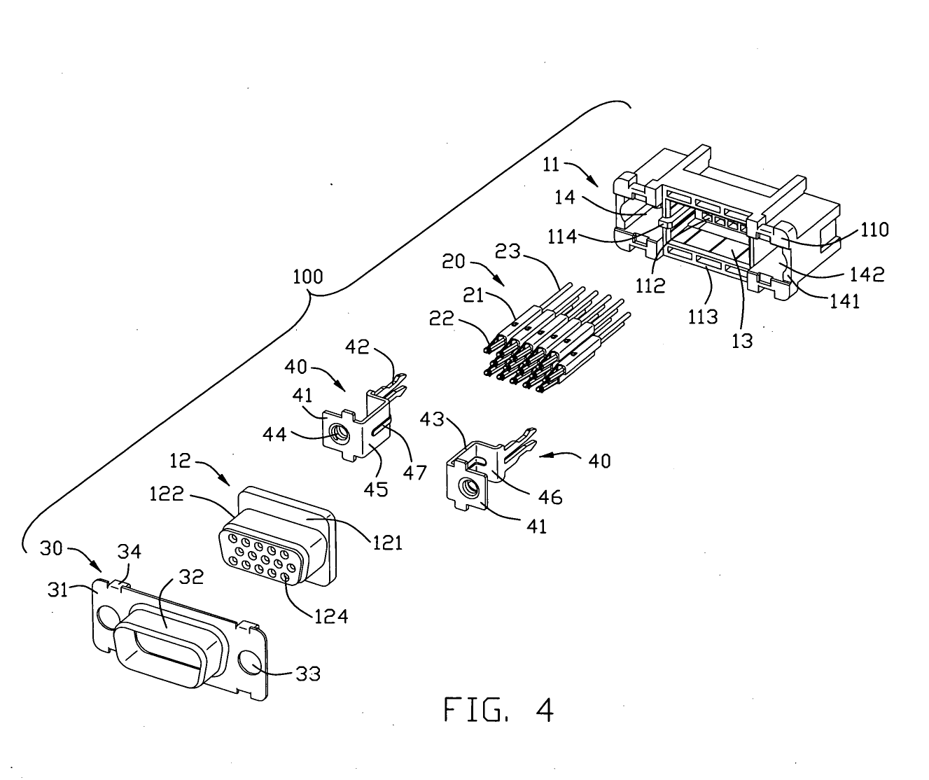

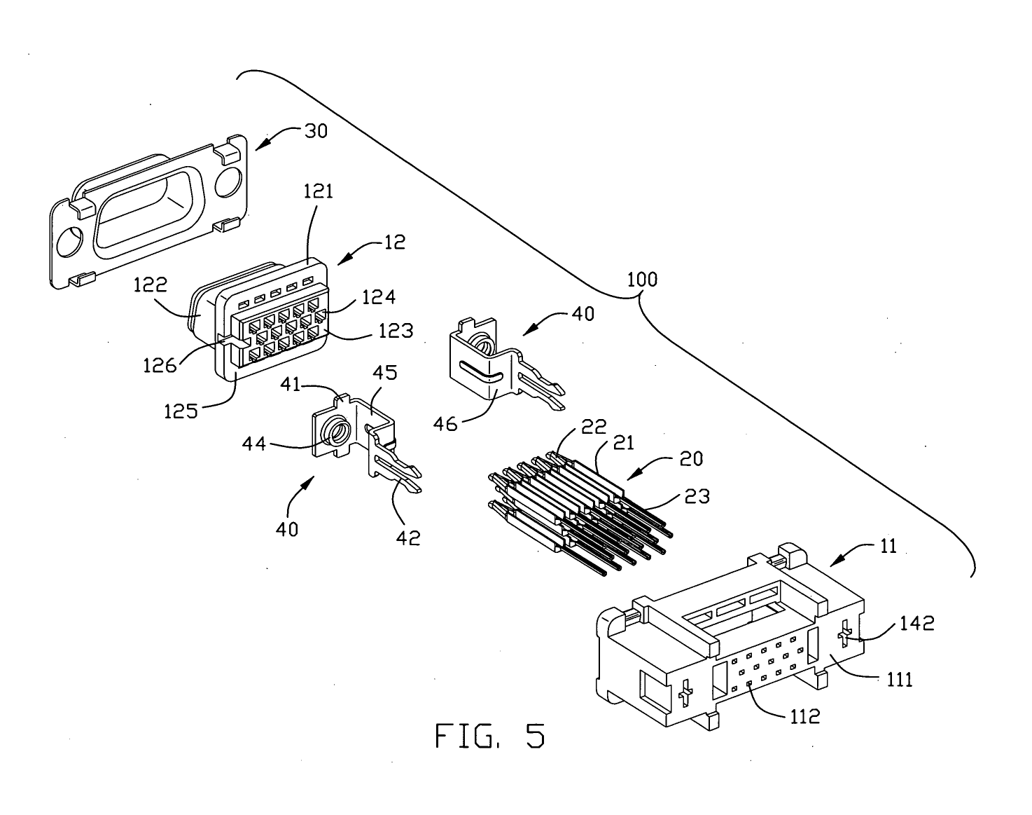

Referring to FIGS. 3-5, the insulative housing 10 having a body portion 11 and a mating portion 12 apart from the body portion 11. The body portion 10 has a front face 110 for contacting with the shell 30 and a rear face 111 opposite to the front face 110 for mounting a mother board (not shown). The body portion 11 defines a central space 13 opening to the front face 110 for receiving the mating portion 12 therein. The body portion 11 further defines a pair of receiving spaces 14 extending therethrough at lateral sides thereof. Each receiving spaces 14 comprises a first recess 141 and a second recess 142. The body portion 11 defines a plurality of through holes 112 behind the central space 13.

The mating portion 12 includes a base plate 121, a front section 122 extending forwardly from the base plate 121, and a rear section 123 opposite to the front section 122. The mating portion 12 defines a plurality of passageways 124 extending therethrough and corresponding to the through holes 112.

The body portion 11 and the mating portion 12 each defines a mating face 113, 125 contacting with each other. The insulative housing 10 further comprises a full-proofing device thereonon. The full-proofing device includes a post 114 and a slit 126 mating with each other. The post 114 is projecting from the mating face 113 to the front face 110 of the body portion 11. The slit 126 is defines on the mating face 125 of the mating portion 12. The post 114 and the slit 126 are only arranged on one side of the insulative housing 10 thereby the body portion 11 and the mating portion 12 can accurately mate with each other and avoid the electrical contacts 20 inserting into the insulative housing 10 by error.

Each electrical contacts 20 comprises a retention section 21 engaging with the passageways 124 of the mating portion 12, a contact section 22 extending forwardly from the retention section 21, and a mounting section 23 connecting with the retention section 21. The mounting section 23 is received in the through holes 112 and projects out of the rear face 111 of the body portion 11.

The board locks 40 are received in the receiving spaces 14 of the body portion 11 and each comprises a first plate 41, a hook section 42 extending out of the insulative housing 10, and a connect section 43 connecting the first plate 41 with the hook section 42. The first plate 41 includes a hollow cylinder 44. The connect section 43 comprises a second plate 45 extending vertically from a side edge of the first plate 41 and a third plate 46 parallel to the first plate 41. The hook section 42 is connected with the third plate 41 and perpendicular thereto. The second and third plate 45, 46 each include a rib 47 thereon for abutting to the body portion 11. The first plate 41 is received in the first recess 141 and the connect section 43 and the hollow cylinder 44 are received in the second recess 142.

The metal shell 3 comprises a flat portion 31 to be attached to the front surface 110 of the body portion 11 and a D-shaped projection 32 protruding forwardly from the mating portion 31. The mating portion 31 defines a pair of through holes 33 on lateral sides thereof and corresponding to the hollow cylinder 44 of the board lock 40. The projection 32 is hollow to define a chamber 320 therein for the front section 123 of the mating portion 12 extending therein. The metal shell 30 also comprises a plurality of retention barbs 34 at top and bottom edge thereof for securing the shell 30 to the insulative housing 10.

The first plate 41 of the board lock 40 is coplanar with the front face 110 of the body portion 11 and contacts with the flat portion 31 of the metal shell 30. The first plates 41 of the board locks 40 are sandwiched by the metal shell 30 and the insulative housing 10 directly without additional fasteners which not only simplify the construction of the electrical connector 100 but also the facilitating the assembly of the electrical connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An electrical connector comprising:
an insulative housing having a body portion and a mating portion projecting from the body portion, the body portion comprising a pair of receiving spaces extending therethrough;
a plurality of contacts retained in the insulative housing;
a pair of board locks each comprising a first plate, a hook section extending out of the insulative housing, and a connect section connect the first plate with the hook section, the first plate including a hollow cylinder extending therefrom; and
a metal shell secured to the insulative housing and defining a pair of through holes corresponding to the hollow cylinders respectively, the metal shell and the insulative housing sandwiching the first plates of the board locks therebetween.

2. The electrical connector as claimed in claim 1, wherein the connect section of the board lock includes a second plate extending vertically from a side edge of the first plate and a third plate parallel to the first plate.

3. The electrical connector as claimed in claim 2, wherein the hook section is connected with the third plate and perpendicular to the first plate.

4. The electrical connector as claimed in claim 3, wherein the second and third plate include a rib thereon for abutting to the insulative housing.

5. The electrical connector as claimed in claim 1, wherein the mating portion is apart from the body portion and extending into in a central space of the body portion.

6. The electrical connector as claimed in claim 1, wherein the receiving spaces of the insulative housing each comprises a first recess and a second recess, and wherein the first plate is received in the first recess and the connect section and the hollow cylinder are received in the second recess.

7. The electrical connector as claimed in claim 6, wherein the metal shell comprises a plurality of retention barbs at top and bottom edge thereof for securing the shell to the insulative housing.

8. The electrical connector as claimed in claim 5, further comprising a full-proofing device arranged on one side of the insulative housing, and wherein the full-proofing device includes a post and a slit mating with each other and being arranged on the body portion and the mating portion, respectively.

9. The electrical connector as claimed in claim 1, wherein the first plate of the board lock is coplanar with a front face of the insulative housing, and wherein the front face of the insulative housing is contact with the metal shell.

10. An electrical connector comprising:
a body portion comprising a central space;
a mating portion apart from the body portion and attached to the central space of the body portion;
a plurality of contacts retained in the body portion and the mating portion;
a metal shell shielding the insulative housing;
a pair of board locks received in the body portion and contact with the metal shell, each board lock comprising a hook section extending out of the body portion; and
a full-proofing device including a post and a slit mating with each other, the post and the slit being arranged on one side of the body portion and the mating portion respectively.

11. The electrical connector as claimed in claim 10, wherein the pair of board locks each includes a hollow cylinder and the metal shell defines a pair of through holes corresponding to the hollow cylinders.

12. The electrical connector as claimed in claim 10, wherein the body portion and the mating portion each defines a mating face to contacts with each other.

13. The electrical connector as claimed in claim 12, wherein the post is projecting from the mating face of the body portion and the slit is defines on the mating face of the mating portion.

14. An electrical connector comprising:
an insulative housing having a body portion defining a pair of receiving spaces at two opposite longitudinal ends with a mating portion therebetween extending forwardly;
a plurality of contacts disposed in the mating portion;
a pair of board locks disposed in the corresponding receiving spaces, respectively, each of said board locks including a locking head extending out of a rear portion of the housing, a plate essentially rearwardly abutting against a front face of the body portion, an internally threaded portion unitarily extending rearward from the plate, under a condition that said board lock and said body portion are configured to prevent movement of the board lock relative to the body portion except forwardly; and
a metallic shell fastened to the housing and defining a flat portion cooperating with the front face of the body portion to tightly sandwich the plate therebetween in a front-to-back direction; wherein
the flat portion of the shell defines an through hole to expose said internally threaded portion to an exterior for allow an external screw to extend therethrough.

15. The electrical connector as claimed in claim 14, wherein said receiving space defines a large front opening and small rear opening to receive the corresponding board lock therein.

16. The electrical connector as claimed in claim 14, wherein the shell is fastened to the housing at positions around the pair of board locks.

17. The electrical connector as claimed in claim 14, wherein said mating portion is discrete from the body portion.

18. The electrical connector as claimed in claim 17, wherein said shell commonly prevents both said mating portion and the board locks from being withdrawn from the body portion.
